(19) United States
(12) Patent Application Publication
(10) Pub. No.: US 2019/0293592 A1
(43) Pub. Date: Sep. 26, 2019

(54) REFERENCE ELECTRODE USING LOCAL ENVIRONMENT PH CONTROL

(71) Applicant: ANB Sensors Limited, Cambridge, Cambridgeshire (GB)

(72) Inventor: Nathan Lawrence, Cambridge (GB)

(73) Assignee: ANB Sensors Limited, Cambridge, Cambridgeshire (GB)

(21) Appl. No.: 16/306,463

(22) PCT Filed: Jun. 5, 2017
(86) PCT No.: PCT/GB2017/051614

§ 371 Date: Nov. 30, 2018

(30) Foreign Application Priority Data
Jun. 3, 2016 (GB) 1609716.4

(51) Int. Cl. G01N 27/30; G01N 27/416

(52) U.S. Cl. CPC G01N 27/301; G01N 27/4161; G01N 27/4167

(57) ABSTRACT

A reference system for an electrochemical or ion selective sensor where a reference electrode is coupled with a redox active species and the redox active species is configured to set a pH value of a local environment of a low buffer/low buffering capacity analyte media proximal to the reference electrode. The pH value of the low buffer/low buffering capacity proximal to the reference electrode may be controlled to a pH value at least one pH unit above or below pH 7. The voltammetric response of the redox active species is used as a reference and/or reference signal for the electrochemical or ion selective sensor.

### BACKGROUND

Embodiments of the present disclosure provide a reference system for an ion selective sensor, for example an electrochemical sensor, a glass electrode, a potentiometric sensor and/or the like. The reference system comprises a reference electrode coupled with a redox active species, wherein the reference electrode is configured in use to contact a low buffer/low buffering capacity media, such that the redox active species controls the pH of the media local to the surface of the electrode. For purposes of the following disclosure the term low buffer is used to describe either a low buffer or a low buffering capacity media, where a common low buffer media comprises water and common low buffering capacity media comprise seawater, saline, KCl or the like, where the media is not a low buffer media and/or may have a high ionic strength, but the media has a low buffering capacity. Additionally, for purposes of the present disclosure the term “local to the surface” means the media environment proximal/local to the surface of the reference electrode. Because the redox active species sets the pH in the low buffer media local to the reference electrode, the reference electrode will see a constant pH and give a constant redox response to this pH. In embodiments of the present disclosure, this constant response is used as a reference for an ion selective/electrochemical sensor.

In chemistry, pH is a numeric scale used to specify the acidity or basicity (alkalinity) of an aqueous solution. It is approximately the negative of the logarithm to base 10 of the molar concentration, measured in units of moles per liter, of hydrogen ions. More precisely it is the negative of the logarithm to base 10 of the activity of the hydrogen ion. Solutions with a pH less than 7 are acidic and solutions with a pH greater than 7 are basic. Pure water is neutral, being neither an acid nor a base.

pH measurements are important in agronomy, medicine, biology, chemistry, agriculture, forestry, food science, environmental science, oceanography, civil engineering, chemical engineering, nutrition, water treatment and water purification, as well as many other applications.

For nearly a century, pH has most commonly been measured using a glass electrode. The glass electrode is a combination electrode that combines both a glass and a reference electrode into one body. The combination electrode consists of the following parts: a sensing part of the electrode, a bulb made from a specific glass; an internal electrode, usually silver chloride electrode or calomel electrode; an internal solution, usually a pH=7 buffered solution of 0.1 mol/L KCl or 1×10⁻⁷ mol/L HCl; a reference electrode, usually the same type with a reference internal solution, usually 0.1 mol/L KCl; a junction with studied solution, usually made from ceramics or capillary with quartz fiber; and the body of electrode, made from non-conductive glass or plastics.

Glass electrodes cannot be used in many industries because of their fragility, requirement of calibration before use and need to be stored under appropriate conditions. In addition, it is well-known in the art that the reference electrode of the glass electrode, normally a silver/silver chloride system, suffers from drift, such that the measurements from the glass electrode are inaccurate. This issue of drift in reference electrode systems, including the silver/silver chloride reference electrode, is well-known and there is an unmet need in the ion selective/electrochemical sensor industry for a reference system that does not drift/does not require recalibration.

A number of chemical analysis tools are known from chemical laboratory practice. Such known analysis tools include for example the various types of chromatography, electrochemical and spectral analysis. Particularly, the potentiometric method has been widely used for the measurements of water composition both in the laboratory and in the field of ground water quality control. U.S. Pat. No. 5,223,117 discloses a two-terminal voltammetric micro sensor having an internal reference using molecular self-assembling to form a system in which the reference electrode and the indicator electrode are both on the sensor electrode. The reference molecule is described as a redox system that is pH-insensitive (no proton transfer), while the indicator molecule is pH sensitive and is formed by a hydroquinone based redox system having a potential that shifts with the pH (the pH sensitive molecule is herein referred to as a redox active species). Both, reference molecule and indicator molecule layers are prepared by self-assembly on gold (Au) microelectrodes. In the known micro-sensor, a pH reading is derived from peak readings of the voltammograms.

Recently there has been significant work in the development of pH sensors for use in the water industry, where the concentration of dissolved buffer is low. Interest in this area stemmed from the work by Compton et al., (see C. Batchelor-McAuley, B. R. Kozub, D. Menshkau, R. G. Compton, Voltammetric Responses of Surface-Bound and Solution-Phase Anthraquinone Moieties in the Presence of Unbuffered Aqueous Media, J. Phys. Chem. C 115, pp. 714-718 (2011)), who showed the use of classical quinone/hydroquinone voltammetry to monitor pH in these systems failed. Compton established that the proton coupled electrochemical process perturbed the pH of the solution locally to the electrode when little or no buffer and/or ionic salt was in the analyte solution. Compton's work suggested the unsuitability of redox active species to measure pH in low buffer analytes.

As well as measuring pH in source water, there is also a need to measure pH in seawater and saline solutions. One important reason for measuring pH in saltwater is to monitor the effects of carbon dioxide in the atmosphere on the pH of the Oceans. As part of its operational definition of the pH scale, the IUPAC defines a series of buffer solutions across a range of pH values (often denoted with NBS or NIST designation). These solutions have a relatively low ionic strength (˜0.1) compared to that of seawater (˜0.7), and, as a consequence, are not recommended for use in characterizing the pH of seawater, since the ionic strength differences cause changes in electrode potential. To resolve this problem, an alternative series of buffers based on artificial seawater have been developed. This new series resolves the problem of ionic strength differences between samples and the buffers, and the new pH scale is referred to as the ‘total scale’, often denoted as pHT. The total scale was defined using a medium containing sulfate ions. These ions experience protonation, H⁺+SO₄²⁻⇄HSO₄⁻, such that the total scale includes the effect of both protons (free hydrogen ions) and hydrogen sulfate ions: [H⁺]T=[H⁺]F+[HSO₄⁻].

Recently there has been significant work in the development of pH sensors for use in the water industry where the concentration of dissolved buffer is low. For purposes of clarification, the water industry concerns the monitoring, management, transport and/or of water, which in general does not contain large amounts of ionic salts or dissolved buffer. Traditionally electrochemical pH sensors have focused on either glass electrode or ISFET technologies, which ultimately suffer from the same inherent issue, drift of the reference systems and thereby requiring constant recalibration. Although a solution to the issue on the ISFET has been proposed which uses a second reference electrode species in a controlled environment to account for drift in the primary electrode, the ISFET electrode still needs to be stored under wet conditions and recalibrated after each series of measurement for validation purposes.

Over the past 15 years, work has been performed on developing a pH sensor utilizing traditional hydroquinone/quinone chemistry as the pH sensing element and where reference electrode drift is overcome in the sensor using a species that is insensitive to pH, similar to the microsensor described above in Wrighton. In all of this work, the examples of the species that are insensitive to pH that have been described/used undergo only an electron transfer process, which limits the molecules that can be utilized. Despite this limitation, such insensitive species provide significant advantages over the traditional reference techniques, as the reference systems using the pH insensitive species can be stored dry and do not require a stable external reference electrode; hence the pH sensor using such a reference system can provide for calibration less operation.

The challenge, however, is to find a stable reference compound capable of surviving deployment over a long period of time and/or being insensitive to varying concentrations of species/contamination found within the solution being tested. To this end a significant amount of focus has been on the use of ferrocene based species, which species undergo a one electron oxidation to the resulting ferrocenium ion. Judicious manipulation of the ferrocene structure enhances stability, however polymeric based ferrocene has shown to suffer from electron mobility issues through the ferrocene chain. In addition, several ferrocene molecules have been shown to have redox potentials sensitive to the concentration and type of anion species in the solution being tested and hence can only be used as a reference when the anion system does not change greatly. In addition, ferrocene reference systems need to be calibrated in the local environment prior to deployment.

A problem for pH sensors, ion selective sensors, glass electrode sensors and electrochemical sensors, is the need for a stable reference electrode. In the glass electrode described herein, the reference electrode in KCl solution can drift during operation making the probe inaccurate. With electrochemical sensors using redox systems, references similar to those used in the glass electrode will also drift. Moreover, use of redox sensitive species that provide an electron, such as ferrocene, as a reference are problematic because the ferrocene is difficult to stabilize on the electrode and the redox potential of the species may drift because of the instability. To-date, the reference electrode has been a major issue with ion selective sensors, electrochemical sensors, glass electrodes and/or the like. Electrochemists often suggest using the power supply as a reference to avoid the issues discussed herein, but even the power source cannot provide a stable reference. In addition, the current reference systems, such as calomel, silver-silver chloride systems and/or the like may not be usable for certain applications as they are bulky, disposed in a chamber behind a frit or the like, and so may not be suitable for sensors for use in confined spaces/locations, such as medical/pharmaceutical sensors, microfluidics and/or the like.

### SUMMARY

In embodiments of the present invention, a redox active species is coupled with a reference electrode and the reference electrode is configured to contact a low buffer/low buffering capacity media, such that the redox active species sets the pH of the environment local to the surface of the reference electrode surface. In embodiments of the present disclosure, the voltammetric response of the reference electrode, when in contact with a low buffer media, to an applied voltammetric sweep includes a singularity, a peak or a trough, which corresponds to the pH of the local environment set by the redox active species. The local environment pH set by the redox active species is a constant/absolute set by the chemistry of the redox active species; i.e., set by the consumption/release of protons specific to the redox active species' chemistry. Similarly, the potential of the peak and/or trough in the voltammetric response is also a constant/absolute set by the local pH and the chemistry of the redox active species. As such, the response of the reference electrode in a low buffer media is a constant that can be used as a reference for an ion selective/electrochemical sensor.

In some embodiments, the reference electrode may comprise a “naked” electrode that is configured for use in a sensor that is configured to be used to measure properties of an analyte in a solution, where the solution comprises a low buffer solution, such as water, seawater, saline solution, KCl, AgCl and/or the like. For example, the sensor may be a sensor designed to measure pH of water or seawater or to measure pH or presence of a particular ion in a low buffer solution, such as for example a saline solution in a medical system or the like. In other embodiments, the reference electrode may be disposed behind a frit or the like in a chamber containing a low buffer solution/media so that the sensor to which the reference system is attached may be used to measure properties of high buffer/high buffering capacity solutions/media.

Preferably, n some embodiments, the redox active species may comprise a redox active species that sets the local environment pH to a level that greater than one pH unit from a pH of 7; i.e., the redox active species sets the pH to a level of 6 or less or to a pH of 8 or greater. It is preferable to set the pH a distance from a pH of 7 as many of the low buffer solutions/media, such as water, will set a pH close to 7. By way of example, anthraquinone and quinone derivatives, such as bennzoquinone, anthraquinone, napthoquinone will set a high (alkaline) pH for the local environment and phenylenediamines, phenols, phenothiazines, hydroquoinone etc. will set a low (acidic) pH for the local environment. In some embodiments, acidic or alkaline moieties may be attached to the redox active species to control the pH of the local environment.

Previously, in electrochemical sensing, as noted by Compton et al., the fact that a redox species controls the pH of the environment local to an electrode was seen as detrimental, since the redox species in such a system could not be used to measure the actual pH of the analyte. However, it was realized by the inventors of the present system that the effect of the redox active species controlling the pH of the local environment could be used in a reference system, since the pH of the local environment of the electrode when contacted with a low buffer solution is an absolute determined by the chemistry of the redox active species and the response of the redox active species to that pH. Applicants have found that reference species that can control the local environment of the reference electrode can facilitate the use of redox active species as reference species by using the correct functionalisation and an understanding of the environment in which the sensor will be immersed.

In some embodiments, the redox active species (sometimes referred to herein as the reference species for conciseness) is configured to control the local environment under certain conditions, where these conditions are provided by the solution being tested by the sensor. For example, redox active can be used to control the local environment of the reference electrode system when the reference electrode is being used in water, seawater, saline solutions, KCl, AgCl or the like, where the solution being tested has low a low natural buffer potential or a low buffering capacity. In water/seawater/saline solutions or the like, because of the low natural buffer potential/low buffering capacity, the redox active species can be used to set the local pH for the reference electrode to greater than one pH unit from pH 7. If however, the buffer potential or buffering capacity of the solution being tested is high, the pH of the solution will control the pH of the environment local to the reference electrode. In such aspects, because the pH properties of the redox active species are known, the reference may be used to determine buffer potential/buffering capacity of the solution.

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an electrochemical sensor using a reference system in accordance with embodiments of the present invention, where the reference electrode system is used as an additional working electrode combined in a three electrode set-up.

FIG. 2 illustrates an electrochemical sensor comprising a reference electrode system in accordance with the present disclosure held with a potassium chloride (KCl) solution and electrically connected to the analyte solution through a frit, wherein the reference electrode system is used as an additional working electrode combined in a three electrode set-up.

FIG. 3 illustrates an electrochemical sensor comprising a reference electrode in accordance with the present disclosure held with a potassium chloride (KCl) solution where the reference electrode is placed behind a frit and used as a classical reference electrode in a three electrode electrochemical system.

FIG. 4 illustrates that a redox active species, anthraquinone, sets pH of the local environment of an electrode such that the electrode produces a voltammetric response in accordance with the set pH.

FIG. 5 is a flow-type illustration of operation of a reference electrode system in accordance with the present disclosure.

### DESCRIPTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments maybe practiced without all the specific details. For example, circuits may be shown in block diagrams in order not to obscure the embodiments in unnecessary detail. In other instances, well-known circuits, processes, algorithms, structures and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded or transmitted via any suitable means including memory sharing, message passing, token passing, network transmission, etc.

Reference will now be made in detail to embodiments, examples of which are illustrated in the accompanying drawings and figures. In the following detailed description, numerous specific details are set forth in order to provide a thorough understanding of the subject matter herein. However, it will be apparent to one of ordinary skill in the art that the subject matter may be practiced without these specific details. In other instances, well known methods, procedures, components, and systems have not been described in detail so as not to unnecessarily obscure features of the embodiments. In the following description, it should be understood that features of one embodiment may be used in combination with features from another embodiment where the features of the different embodiment are not incompatible.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step. The first object or step, and the second object or step, are both objects or steps, respectively, but they are not to be considered the same object or step.

The terminology used in the description of the disclosure herein is for the purpose of describing particular embodiments only and is not intended to be limiting of the subject matter. As used in this description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting”, depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of the present disclosure provide a reference electrode system comprising a redox active species that sets the pH of a low buffer media local to the reference electrode surface. A voltammetric response from the redox active species will include features/singularities corresponding to the set pH of the local environment of the reference electrode. These features/singularities in the voltammetric response can be used as a reference for an ion selective/electrochemical sensor. For example, a redox active species will produce a peak redox current at a potential that corresponds to the pH of the local environment of the reference electrode, and this potential can be used as a reference against which measurements from an ion selective/electrochemical sensor can be made. For signal processing purposes, features other than the actual singularities in the voltammetric response may be used for processing the voltammetric response to generate a reference signal.

In embodiments of the present disclosure, the reference electrode is either configured for use directly in a solution being tested by the sensor, where the solution is a low buffer solution, or is disposed behind a frit or the like in a low buffer solution. A voltammetric sweep is applied to the reference electrode and a voltammetric response of the reference electrode is processed. The voltammetric response will include features/singularities with properties that depend upon the pH of the local environment of the reference electrode, and because this pH is set by the redox active species the voltammetry response provides a reference from which measurements from a sensor can be processed. In some embodiments, signal processing or the like may be used to measure the properties of the voltammetric response. Advantageously, because the location of the features/singularities can be predicted based upon the pH set by the redox active species and the response of the redox active species to the set pH, weightings can be given to expected locations of features/singularities and used in the signal processing. Additionally, in some embodiments, the voltammetric sweep may be tailored to sweep potentials around expected locations of features/singularities in the voltammetric response.

In embodiments of the present disclosure, the reference system may be used in a sensor configured to measure properties of or detect ions in low buffer solutions, such as water, seawater, saline solutions, KCl, AgCl and/or the like. In other sensors, the reference electrode may be disposed in a low buffer reference solution. Advantageously, the voltammetric response of the reference electrode may be used to identify issues with the reference system. For example, appearance of additional features in a voltammetric sweep may identify contamination/break down of the reference solution contacting the reference electrode. Large movement of features/singularities in the voltammetric response may also correspond to contamination of the reference solution contacting the reference electrode or breakdown, loss of the redox active species from the reference electrode. In reference systems where the reference electrode is directly in contact with the solution/media being tested, changes in the location of features/singularities in the voltammetric response may be used to determine a buffer level/ionic strength of the media.

Embodiments of the present disclosure may use the following redox active chemical structures (shown below) for the reference electrode, in which the redox active component molecule comprises carboxylic, sulfonic and/or amino moieties, in conditions in which the buffer concentration within the solution being tested/reference solution does not overwhelm the concentration of acid/base moieties of the redox active component molecule local to the surface; such that the pH of the reference electrode surface is that of the pKa of the moiety.

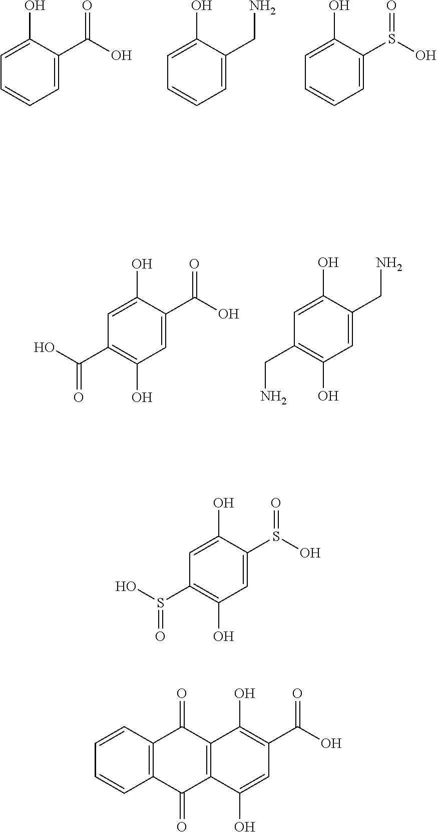

In certain cases, such as that of salicylic acid (top left structure above), a redox active-pH active polymeric layer can be formed containing carboxylic acid moieties. In certain cases where the buffer concentration of the media being tested/reference solution does not overwhelm these moieties, the redox active components of the polymer only observes a pH local to the reference system consistent with that of the pKa of the molecule/moieties. Indeed, in certain embodiments of the present disclosure, as described below, a second reference system can be used to provide a qualitative idea of the buffer concentration and a third electrode can be used to determine the pH of the low salinity and/or low buffered media.

While the structures described above illustrate redox active species with “express” acidic or alkaline structures, many redox active species, such as for example, phenylenediamines, phenols, phenothiazines, hydroquoinone and derivatives thereof will set an acidic local pH and quinones (bennzoquinone, anthraquinone, napthoquinone), or derivatives will set an alkaline pH for the local environment.

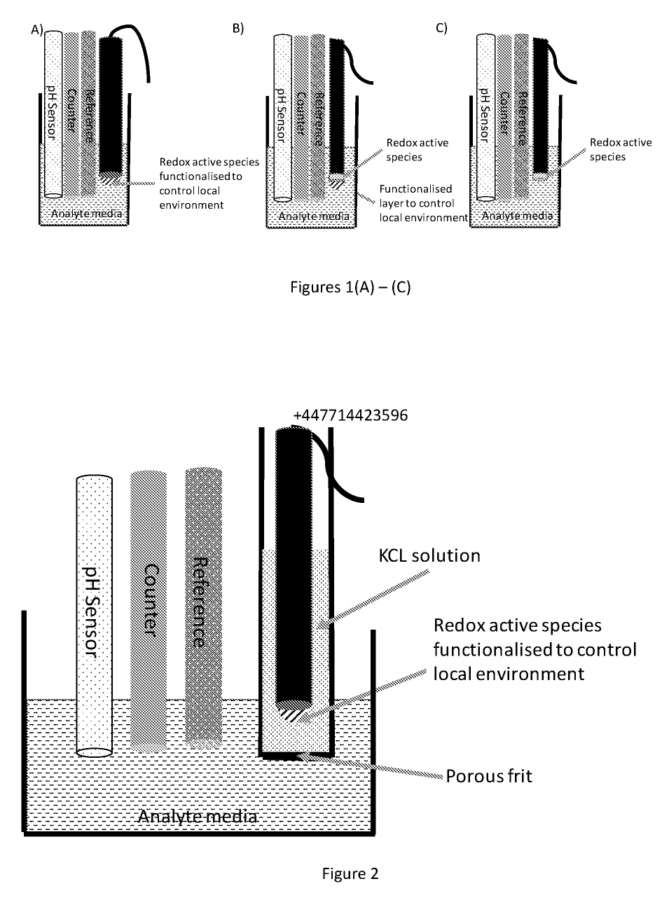

FIGS. 1(A)-(C) illustrate an electrochemical pH sensor comprising a reference system in accordance with embodiments of the present disclosure. The reference system is configured for use in a low buffer analyte media.

In FIGS. 1(A)-(c), the system is run using a conventional electrochemical set-up with external reference and counter electrodes and incorporates the new reference electrode system and a pH sensing electrode. Upon application of a potential ramp, the redox active species of the reference system will be oxidized and reduced and show a potential consistent with the controlled local environment, whereas the pH sensitive electrode will provide a potential consistent with the pH of the analyte. The difference in the redox potential of the new reference system and the pH sensing electrode provides the pH of the solution, independent of any drift from the external electrochemical reference electrode.

In certain embodiments, the reference electrode system may comprise a single layer in which a redox active species is configured to control the pH of the local environment of the reference electrode. The redox active species may comprise a regular redox active species such as anthraquinone or the like or may be a redox active species that includes directly attached moieties to control the local environment (FIG. 1(A)). In some embodiments, the reference electrode system may comprise a dual layer in which the redox active species is separated/independent from a further chemical species that is used to control the local environment of the reference electrode (FIG. 1(B)). In other embodiments, the redox active species used within the reference electrode system by virtue of its oxidation or reduction properties can control the pH local to the surface of the reference electrode through the release/loss or gain of protons (FIG. 1(C)), i.e., the redox active species itself acts as the chemistry that sets the pH local environment of the reference electrode.

In FIGS. 1(A) through (C), the reference electrode is described as part of a pH sensor. This has been done merely by way of example as the reference system may be used as part of other types of ion selective/electrochemical sensors. For example, a sensor for electrochemically measuring the presence of an ion/analyte in a saline solution, such as for example potassium, ammonium, sodium, phosphate, chloride, nitrate, nitrite, and/or the like, may use the reference output from the reference system of the present disclosure as the baseline against which its output is measured. Advantageously, because the reference system of the present disclosure, when used in a sensor being used in a low buffer analyte media can comprises a naked electrode without a frit of the like, the reference system can be used in microfluidic systems, in-vitro or extra-vitro sensors and/or the like.

The reference electrode may comprise a conducting/conductive substrate, which substrate may comprise: graphene, carbon nanotubes, carbon, glassy carbon, graphite, diamond, boron doped diamond or the like. The conducting/conductive substrate may comprise a wire, such as a carbon or graphene wire. In some embodiments, a paste/mixture of the redox active species may be formed and coupled with the electrode. For example, a paste/mixture of the redox active species formed with carbon may be disposed in a cavity in the electrode. The paste/mixture may include a binder/epoxy to hold the mixture together. In some embodiments, the electrode maybe produced by printing conductive inks containing the redox active species onto a substrate using screen printed, pad printed, flexiographic or rotar gravure printed technologies. Graphene and/or carbon nanotubes have been found as good material for the electrode substrate as they are strong, provide good/regular conductivity, provide for uniform polymerization of the redox active species onto the substrate and can be used in micro-type electrode systems.

Advantageously, the active redox active species may be selected to be insoluble in aqueous media, and therefore may be solvent cast onto the electrode surface. However, in some embodiments of the present disclosure, the active redox active species may be included in a carbon paste or a carbon epoxy, immobilized within an electrode using a carbon press, screen-printed onto an electrode and/or the like. In fact, many of the active redox species described herein may form versatile redox polymers that can be effectively applied to the reference electrode.

Merely by way of example, operation of a pH sensor is described for use in ocean and source water environment. Of course, sensors for other analytes in different environments can be used with the reference electrode described herein, but ocean and/or source water environment is one of the most challenging environments for a reference electrode because the water/seawater may contain low natural buffer capacity and/or ionic salt. Indeed, in certain aspects of this invention, described below, a second reference system can be used to provide a qualitative idea of the buffer concentration of the media and a third electrode can be used to determine the pH of the low buffer media.

For the environments which have a high buffering capacity and hence would overwhelm the ability of the redox active species to control the pH of the local environment of the reference electrode, the new reference electrode system described herein may be enclosed in a low buffer solution. In some embodiments, the redox active reference electrode may have electrical contact to the analyte media through a porous frit, similar to frits used in conventional reference electrode systems.

FIG. 2 details an embodiment of this architecture in which the new reference electrode system is held within a KCl solution or the like (other low buffer analyte media, such as saline solution or the like may be used, but KCL was selected for the example, because it like AgCl is a well-established reference analyte). This design offers a double protection with the local environment resisting perturbations in the bulk changes in the KCL through ion transport across the frit (i.e. it would take dehydration disrupt effective operation of the reference electrode). The system as shown FIG. 2 would be used in the same way as the sensor system described in FIG. 1, in terms of reference system operation. Essentially, the chemistry of the redox active species of the reference electrode sets the pH of the environment in the KCl solution local to the reference electrode and the redox active species records this local pH as a reference, which is communicated to the sensor processor and used as a reference signal.

The sensor of FIG. 2 may comprise any kind of ion selective or electrochemical sensor. The reference is superior to and meets the long-felt need in the ion selective/electrochemical sensor art, because the redox active species when in contact with the low buffer analyte media sets a pH of the local environment of the electrode, the pH corresponding to the chemical properties of the redox active material, which may be set by the presence of acidic or alkaline moieties in the redox active species or the oxidation or reduction properties of the redox species (the ability of the redox active to take up or donate protons) sets the local pH.

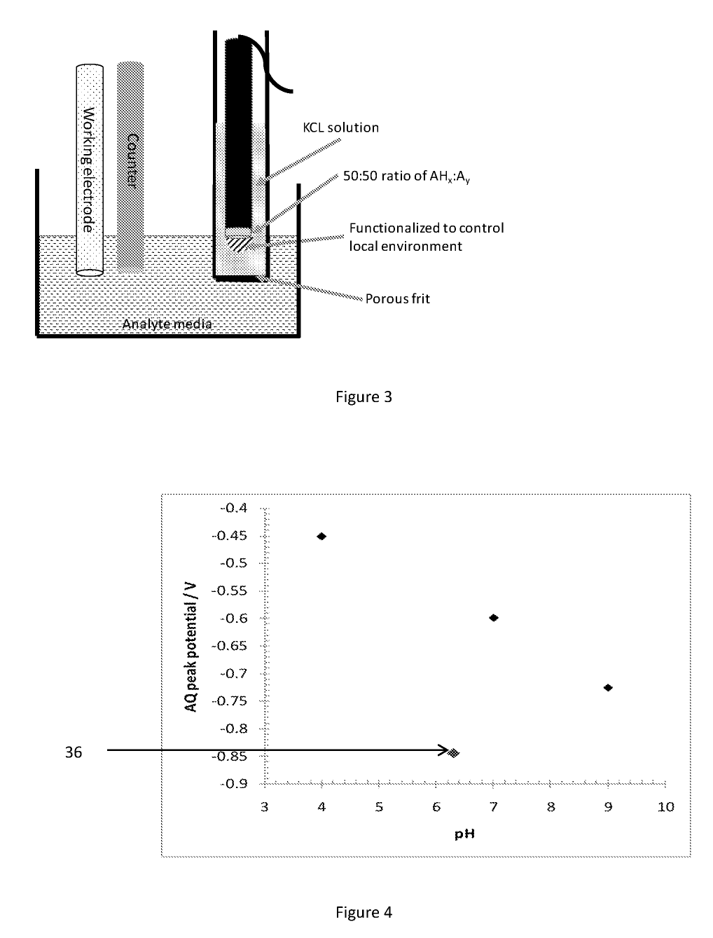

In certain cases, the external reference electrode can be replaced with the new reference system, as illustrated in FIG. 3, where the redox active reference electrode is placed behind a frit. In this case, the redox active species is first oxidized/reduced in a controlled manner to set up a redox potential at the surface of the electrode consistent with the ratio of oxidized to reduced species on the surface. This illustrated system can then be used as a conventional three electrode reference electrode system.

FIG. 4 illustrates that a redox active species, anthraquinone, sets the pH of the environment local to an electrode when the redox active species is contacted with a low buffer solution/media, and that the redox active species produces a voltammetric corresponding to the set pH of the local environment.

In FIG. 4, the redox active species produces a linear series of voltammetric responses (peak potentials) when placed in a series of different pH buffer solutions. This is true of all redox active species and the linear response is used to determine pH of the solution from the voltammetric response of the redox active species. However, point 36 on the graph shoes the voltammetric response of anthraquinone when it is disposed on an electrode and disposed in a low buffer/low buffering capacity solution, in this case an aqueous solution with a pH of approximately 6.5. The voltammetric response of the anthraquinone is not on the expected linear response line, and in fact corresponds to a pH of just over 10. This voltammetric response of anthraquinone is the same for any low buffer/low buffer capacity solution, water, seawater, KCl and or the like, and show that the anthraquinone is creating an alkaline solution proximal to the electrode surface. The redox species sets the pH local to the reference by either consuming or releasing protons, depending upon the chemistry of the redox active species. Most importantly, a redox active species will set the same local pH in the low buffer/low buffer capacity solution since the pH is purely dependent upon the chemistry of the redox active pH species, the number of protons released or consumed by this chemistry. Consequently, the redox active species provides a reference voltammetric response when placed in a low buffer/low buffering capacity solution. Advantageously, because the location of the voltammetric response, such as the peak voltage, is known, the position can be used when processing the voltammetric response of the redox active species in the field/in the reference system of a sensor.

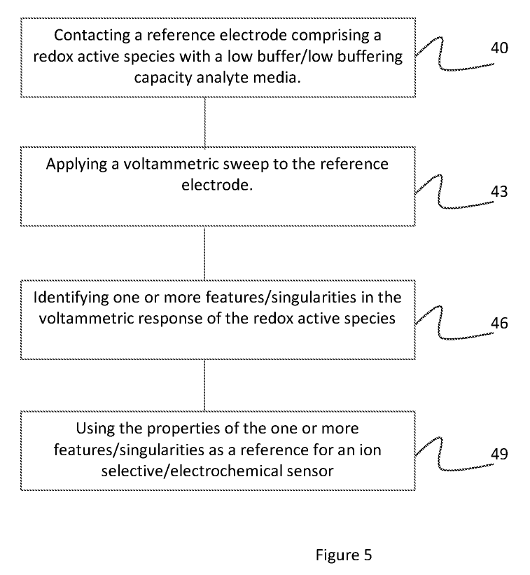

FIG. 5 illustrates a flow-type schematic of use of a reference electrode system in accordance with embodiments of the present disclosure in an electrochemical or ion selective sensor.

In step 40, a reference electrode comprising a redox active species, in accordance with embodiments of the present disclosure, is contacted with a low buffer solution/analyte media.

The redox active species is selected to control the pH of the low buffer analyte media proximal to the reference electrode. The redox active species may control the proton level/concentration proximal to the reference electrode, thus setting the pH, or may comprise acid or alkaline moieties that set the local pH. In preferred embodiments, the pH proximal the reference electrode is controlled to be more than one pH unit from a pH of 7. The analyte media may either comprise the analyte media being tested/measured by the sensor or a reference low buffer analyte media disposed with the reference electrode behind a frit.

In step 43, a voltammetric sweep is applied to the reference electrode. In some embodiments, the voltammetric sweep may comprise a square wave voltammetric sweep, a linear sweep or the like. The voltammetric sweep may be applied by a potentiostat or the like. In some aspects only a portion of a full voltammetric sweep may be applied to the reference electrode, where the portion of the sweep is selected to cover a redox potential of the redox species corresponding to the pH set by the redox active species.

In step 46, the voltammetric response of the redox active species to the applied voltammetric sweep is processed and features/singularities are identified in the voltammetric response. The redox active species will have a peak redox potential corresponding to the pH of the local environment set by the redox active species. Similarly, the redox response will have a singularity corresponding to a reduction current corresponding to the pH of the local environment set by the redox active species. Other features in the voltammetric response such as turning points, locations of maximum change in the response and/or the like may be processed from the voltammetric response.

In step 49, the processed properties of the one or more features/singularities (the peak potential) may be used as a reference for an ion selective/electrochemical sensor. As described above, in the reference system of the present disclosure, the redox active species sets the pH of the low buffer analyte media proximal to the reference electrode. The pH depends upon the redox properties of the redox active species and/or the presence of acid or alkaline moieties in the redox species structure. Both of these properties will give rise to a specific pH when the redox active species is in contact with a low buffer analyte media, such as water, seawater, saline solution, KCl, AgCl and/or the like.

When the voltammetric sweep is applied, the voltammetric response of the redox active species is determined by the chemistry of the redox active species and the pH of the local environment of the low buffer analyte media proximal to the reference electrode. Since the pH is set by the redox active species, which is a constant, and the response of the redox active species to this pH is also a constant, the reference system provides a constant, reference output that can be used by the ion selective/electrochemical sensor against which its variable measurements (pH, ion concentration etc.) can be processed. Unlike conventional reference systems, the reference system of the present disclosure does not drift, does not need re-calibration and/or the like. In some embodiments of the present invention, the response of the reference electrode can be calculated so there is no need for even an initial calibration. However, in practice, batch calibration of the reference electrodes may be performed when manufactured before being sold and used. In some embodiments, the actual voltammetric response of the redox active species may be processed and used to determine the health of the reference system.

While the principles of the disclosure have been described above in connection with specific apparatuses and methods, it is to be clearly understood that this description is made only by way of example and not as limitation on the scope of the invention.

1. A reference system for an ion selective/electrochemical sensor comprising:
a reference electrode coupled with a redox active species, wherein the redox active species is configured in use to contact a low buffer/low buffering capacity analyte media, characterized in that the redox active species is configured to set a pH of a local environment of the low buffer/low buffering capacity analyte media proximal to the reference electrode.

2. The reference system of claim 1, wherein the redox active species is configured to control the pH of the local environment to a pH value greater than one pH unit from pH 7.

3. The reference system of claim 1, wherein the low buffer/low buffering capacity analyte media is contained in a chamber behind a frit and the reference electrode is disposed in the chamber in contact with the low buffer/low buffering capacity analyte media.

4. The reference system of claim 3, wherein the frit comprises a porous frit configured to provide electrical/ionic conductivity between a solution being tested by the electrochemical/ion selective sensor and the low buffer/low buffering capacity analyte media.

5. The reference system of claim 1, wherein the low buffer/low buffering capacity analyte media comprises a conductive salt solution.

6. The reference system of claim 5, wherein the conductive salt solution comprises KCl or AgCl.

7. The reference system of claim 1, wherein the redox active species is configured to consume or release sufficient protons to saturate buffer effects of the low buffer/low buffering capacity analyte media in the local environment of the reference electrode and to set a pH local to the electrode.

8. The reference system of claim 1, wherein the redox active species comprises a redox chemistry that controls proton concentration proximal to the reference electrode.

9. The reference system of claim 1, wherein the redox active species comprises one of a quinone or a derivative thereof, a phenylenediamine, a phenol, a phenothiazine or a hydroquoinone.

10. The reference system of claim 1, wherein the redox active species comprises acidic or basic moieties.

11. The reference system of claim 1, wherein the reference system comprises a redox active and pH active chemical species that contains acidic or basic moieties and has a redox potential consistent with the pKa of the acidic or basic moieties.

12. The reference system of claim 11, wherein the pH active chemical species comprises one of the following chemical structures:

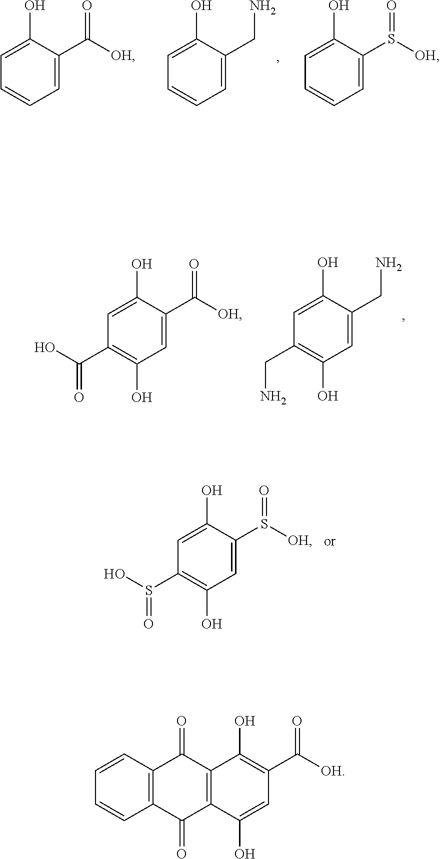

13. The reference system of claim 11, wherein the pH active chemical species comprises a salicylic acid based polymer.

14. The reference system of claim 1, wherein the redox active species is immobilized within or upon carbon epoxy or carbon paste, or is screen-printed, pad printed, flexiographic or rotar gravure printed on the reference electrode.

15. The reference system of claim 1, further comprising a separate chemical species comprising acidic or basic groups configured to control pH of the low buffer/low buffering capacity analyte media.

16. The reference system according to claim 1, further comprising a potentiostat configured to apply a voltammetric sweep to the reference electrode.

17. The reference system according to claim 16, wherein the redox active species generates a voltammetric response to the applied voltammetric sweep and the voltammetric response is determined by the pH of the low buffer/low buffering capacity analyte media proximal to a surface of the reference electrode.

18. The reference system according to claim 17, wherein the redox response is used as a reference for the ion selective/electrochemical sensor.

19. The reference system according to claim 17, wherein the ion selective/electrochemical sensor is configured to measure properties of the low buffer/low buffering capacity analyte media.

20. The reference system according to claim 1, wherein the low buffer/low buffering capacity solution comprises water, seawater or a saline solution.

21. The reference system according to claim 1, wherein the reference electrode comprises graphene or carbon nanotubes.

22. The reference system according to claim 1, wherein the reference electrode comprises a carbon or graphene wire.

23. A method for providing a stable reference for an electrochemical or ion selective sensor, comprising:
contacting a reference electrode comprising a redox active species with a low buffer/low buffering capacity analyte media, wherein the redox active species is configured to set a pH of a local environment of the low buffer/low buffering capacity analyte media proximal to the reference electrode;
applying a voltammetric sweep to the reference electrode; and
using properties of a feature/singularity in a voltammetric response of the redox species to the voltammetric sweep as a reference for the electrochemical or ion selective sensor.

24. The method of claim 20, wherein the low buffer/low ionic strength analyte comprises one of water, seawater, saline solution, KCl or AgCl.
